(19) United States
(12) Patent Application Publication
(10) Pub. No.: US 2018/0357833 A1
(43) Pub. Date: Dec. 13, 2018

(54) SYSTEM AND METHOD FOR DYNAMICALLY CREATING CONTENT IN A THREE-DIMENSIONAL VIRTUAL ENVIRONMENT

(71) Applicant: 5th Planet, Inc., Jupiter, FL (US)

(72) Inventors: Sean Biganski, Jupiter, FL (US); Stephen McIntosh, Jupiter, FL (US)

(21) Appl. No.: 16/002,864

(22) Filed: Jun. 7, 2018

Related U.S. Application Data
(60) Provisional application No. 62/516,186, filed on Jun. 7, 2017.

(51) Int. Cl. G06T 19/20; G06Q 30/02

(52) U.S. Cl. CPC G06T 19/20; A63F 13/61; G06Q 30/0251

(57) ABSTRACT

Content in a three-dimensional virtual environment is dynamically created by creating at least one blank placeholder within a three-dimensional virtual environment; the blank placeholder having a blank placeholder graphic information, the blank placeholder graphic information including the virtual shape and dimensions of the blank placeholder, a unique project identification code and a unique developer identification code. The blank placeholder graphic information is stored. A virtual content asset having a a virtual content asset graphic information, and at least one business logic rule associated there with for displaying the virtual content asset is created and paired with the blank placeholder graphic information by matching the blank placeholder graphic information with the virtual content asset shape information. It is then determined whether a business logic rule of the one or more business logic rules is satisfied, and when the business logic rule is satisfied, inserting the virtual content asset on the blank placeholder.

### CROSS-REFERENCE TO RELATED APPLICATIONS

This application claims priority to and the benefit of U.S. Provisional Application No. 62/516,186, filed Jun. 7, 2017, the entire contents of which are herein incorporated by reference in their entirety.

### BACKGROUND OF THE DISCLOSURE

This disclosure is directed to a system and method for creating content in a three-dimensional virtual environment, more particularly, a system and method for changing content within a three-dimensional virtual or augmented reality environment, without affecting the remainder of the environment.

It is known in the art to create environments of virtual and augmented realities utilizing head mounted displays. It is also known in the art among game developers, by way of example, to place advertisements within the game environment. The games are enabled to receive and display banner type ads within the game environment to be displayed during gameplay. However, these banner type ads are incongruous to the environment overlaying or taking up portions of desirable display real estate. They often take up the entire screen, detracting from the game environment and realistic feel, diminishing the user experience. While game producers desire advertising on the display screen of virtual-reality games, users do not want graphics detracting from the reality of the game environment experience.

Additionally, in prior art immersive virtual-reality environments, while it is known to place digital content on objects within the environment, i.e. real world logos on real-world devices, such as a Coke® logo or name on a soda can within the virtual environment, that element is created as part of the original hard coding of the environment and cannot be readily changed without rewriting the original code. Because it is static and cannot be changed without rewriting of the code it limits the use of logos within the virtual world environments. Secondly, as insertions grow stale, there is a need and desire to change the nature or brand of the object within the environment. This cannot be done without interruption of the game to re-create at least portions of the environment in which the object exists.

To overcome some of these shortcomings it is known in the art to create blank canvas portions within the virtual reality environment in which game objects such as a chair, or a car are to be placed. A library of assets is associated with that blank space within the environment, and the game itself retrieves the asset image for that blank space. However this is a closed universe solution which requires the creation of the object database to match the foreseen needs for environment objects.

Accordingly, a system and method which overcomes the shortcomings of the prior art is desired.

### SUMMARY

Content in a three-dimensional virtual environment is dynamically created by creating at least one blank placeholder within a three-dimensional virtual environment; the blank placeholder having a blank placeholder graphic information, the blank placeholder graphic information including the virtual shape and dimensions of the blank placeholder. The blank placeholder graphic information is stored. A virtual content asset having a virtual content asset graphic information, and at least one business logic rule associated therewith for displaying the virtual content asset is created. The blank placeholder is paired with a virtual content asset by matching the blank placeholder graphic information and the virtual asset graphic information. It is then determined whether a business logic rule of the one or more business logic rules is satisfied by placement of the matched virtual asset graphic information into the matched blank placeholder, and when the business logic rule is satisfied, inserting the matched virtual content asset as the blank placeholder.

### BRIEF DESCRIPTION OF THE DRAWINGS

The present disclosure is better understood by reading the written description with reference to the accompanying drawings in which like reference numerals denote similar structure and refer to like elements throughout in which:

FIG. 1 is a schematic view of a system for performing the method in accordance with the disclosure; and

FIG. 2 is an operational drawing of the method and system for performing the one or more embodiments of the disclosure.

### DETAILED DESCRIPTION OF THE DISCLOSURE

For the purposes of this description, the example of a three-dimensional gaming environment is utilized. However the system and methodology are equally applicable to any virtual-reality environment in which it is desirable to change the content within the environment without having to rewrite the code creating the environment. Therefore, while the system and method described herein can be used in any augmented or virtual three-dimensional environment, the description below is in connection with the gaming environment for ease of description and not in a limiting sense.

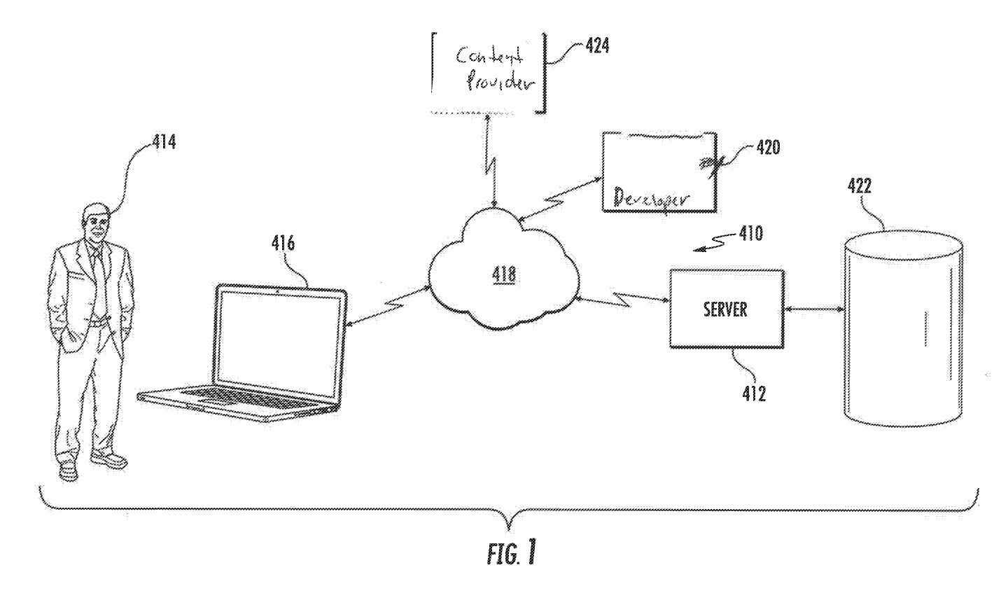

With reference to FIG. 1, a system 410 includes a gaming server 412 associated with a database 422. A content provider 424 remote from the game, communicates with server 412 across the world wide web (distributed network) 418; the cloud.

System 410 enables gamer 414 to communicate utilizing a game console, shown as computer 416, with the gaming server 412 and the associated database 422. At the same time, a content provider 424 desirous of providing content to an existing virtual-reality environment, particularly, when being utilized by gamer 414, communicates with server 412. Additionally, a game developer operating on their own server 420, or on server 412, communicates with server 412 through cloud 418. Game console 416 accesses server 420 or 412, depending upon where the game is hosted. However, in one nonlimiting embodiment, when the environment is hosted by a game developer, server 412 monitors gaming console 416 accessing the three-dimensional environment.

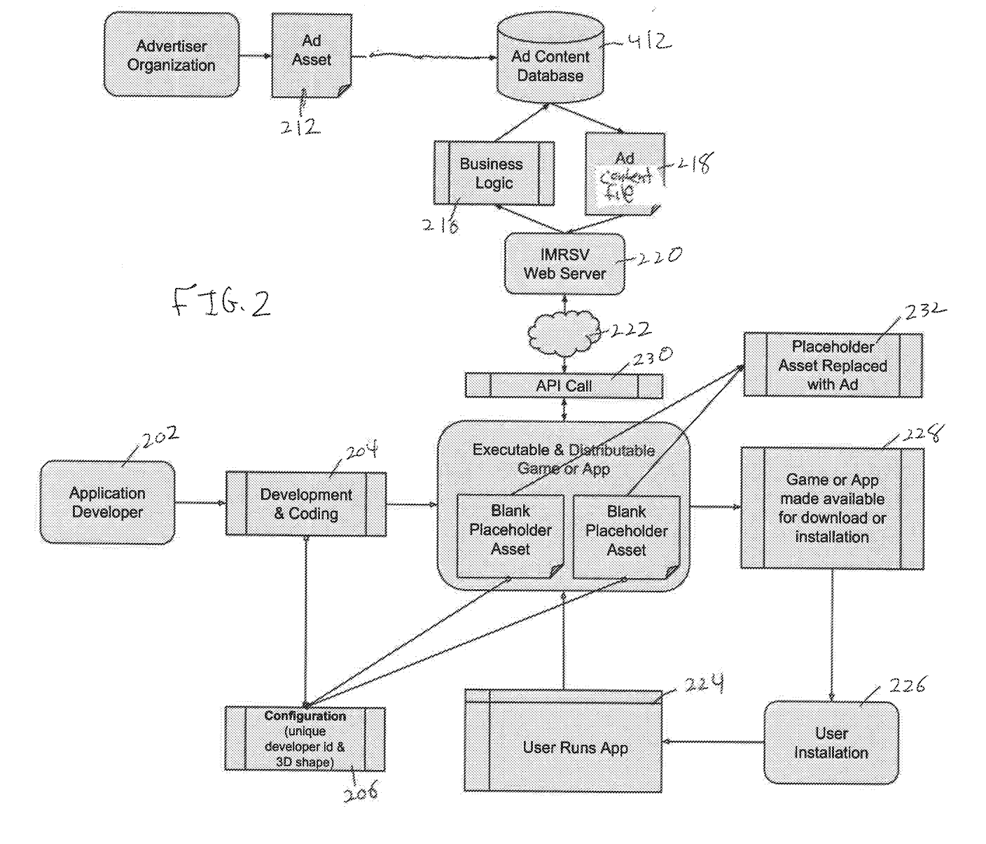

Reference is now made to FIG. 2 in which the methodology for performing the invention by system 410 is provided. In constructing the game, the developer develops and codes the game to create the virtual-reality environment in a step 204 as part of creating the virtual-reality. This may be done with conventional platforms such as Unreal or Unity 3D. However, as part of the environment, the developer now utilizes a blank space generator hosted at server 412, not previously known in the prior art, to create blank placeholder assets; a blank canvas upon which content may be applied as discussed below, within the environment in a step 206.

The blank placeholder, includes an associated shape expressed as graphic information. By way of example, some placeholders may be a can, and therefore have a closed cylindrical shape. Other blank placeholders may be a car having a complex shape in three dimensions, or may be a television screen having a simple two-dimensional shape within the three-dimensional shape of the virtual television. During creation of the blank placeholder assets within a virtual-reality environment, the developer assigns a project identification code, unique to the virtual-reality environment being created, and a developer identification code unique to the developer, which are coded, or pasted, into the virtual-reality environment as part of the blank placeholder asset within the virtual-reality environment.

The shape or graphic information of the placeholder is associated with the project identifier within the virtual environment. These blank placeholders, including the shape graphic information, project identification information and developer identification information, are stored at server 412 as part of a pre-existing library of commonly utilized shapes in database 422, or as created at server 412 by developer 420, are stored in database 422 for future use. As a result, the blank placeholders 240a, 240b are incorporated in an executable and distributable game application in a step 208. It should be noted that in a preferred nonlimiting embodiment, the game is launched with the blank placeholders 240a, 240b therein as blank portions of the three-dimensional environment.

Advertising organizations, desirous of placing advertising content within the three-dimensional virtual gaming environment, create content as an advertising asset in a step 212 which are stored in an ad content database 214 which may be incorporated into, or independent of, database 412. The advertising assets may be graphics, or video capable of completely enveloping a designated three-dimensional space such as blank placeholders 240a, 240b within the three-dimensional virtual environment. The advertising files stored in advertising content database in step 214 include at least two constituent parts. First, it includes the graphic file of the content which includes not only the artistic visual component of the advertising asset, but also shape information for display of the content on blank placeholders 240a, 240b, such as a can shape, a billboard shape, or a television screen to correspond to the exemplary placeholders discussed above by way of non-limiting example. Second, the advertising file also includes business logic rules regarding how, when and where the content of the graphic file is to be used to be inserted within a desired three-dimensional environment. The business logic rules may include a random selection mode or specific timing constraints such as a desired content is only shown during certain hours of the day or evening to target desired audiences. The rules may include, targeting content to specific demographics, as collected from game user registrations, such as, women as compared to men, or different age groups such as a prohibition on use of the advertising asset at adult sites. Lastly, the advertising asset file business logic will include an advertising source identifier to identify the specific content of the file and the organization from which the advertisement originates.

Advertisers desirous of being placed into the developers' games will provide server 412 with, or access to, the advertising asset file including the advertising content file and the business logic file. As a function of the different business logic rules, several sources can be utilized to provide advertising assets to the same blank placeholder asset 240a or 240b within the developer created environment. By way of nonlimiting example, different drink manufacturers may desire to have their drink logo/name be part of the game for specific audiences and during time periods which are not mutually exclusive with a second drink provider. Similarly, an automobile manufacturer may desire for their car designs to be featured in a game as an insertable ad asset for a blank placeholder asset 240a which is the rough shape of a car. Again, depending on the nature of the game, the time of day, or even a date, such as the initial game launch or the one year anniversary date, different car manufacturers can arrange for their graphics to be placed within the game as an ad asset. Additionally different branded products can be substituted for each other as a function of audience demographics determined from user registrations stored in database 422.

When an advertising asset is desired to be loaded into a three-dimensional virtual environment, in a step 220, server 412 matches the advertising asset shape information which conforms to placeholder graphic information for a particular blank placeholder and stores the association in database 422. The ad content file may also be stored in database 422. The ad asset is now ready to be loaded to the three-dimensional virtual environment once the business rules of the advertising asset are satisfied.

In a step 224, user 414 runs the game application at computer 416. When originally called up, the executable game includes the blank placeholder blank placeholders 240a, 240b. In a step 232 the placeholder asset is replaced with the ad asset utilizing an application program interface (API) in a step 230 to call server 412 for an ad asset to be inserted into the appropriate blank placeholder assets 240a, 240b. As discussed above, server 412 first applies the rules associated with the ad asset to select the content eligible to be placed within blank placeholder asset 240a. The rules may be stored in database 422 causing server 412 to communicate with a content provider server 424, or the advertising assets may be stored with the appropriate rules at database 422 to be loaded by server 412 to the server at which the three-dimensional environment is processed. As a result, user 414 is provided with an environment at computer 416 which includes content from the game developer, and the content provider.

As can be seen from the above, by utilizing this system and method discussed above, the game developer may make use of content, including advertising content, from a variety of sources, which may be deployed within a three-dimensional virtual environment without having to change the underlying original code for that three-dimensional virtual environment. Additionally, the insertion of the content can be done as a function of placement rules which may be content specific and enable changing of content as a function of time of day, duration of use, and even audience demographic. While the above example was given in terms of a three dimensional gaming virtual reality environment for ease of description, the system and method described above is also applicable to augmented reality and non-gaming applications for a three-dimensional environment. It should also be noted that the example is in terms of an advertising asset, but is applicable to any virtual content asset having shape information to be deployed onto the blank placeholder.

Thus, there have been shown, described and pointed out novel features of the present invention as applied to preferred embodiments thereof, it will be understood that various submissions and substitutions and changes in the form in detail are contemplated to the disclosed invention which may be made by those skilled in the art without departing from the spirit and scope of one or more embodiments of this disclosure. It is the intention therefore to be limited only as indicated by the scope of the claims appended hereto. It is also to be understood that the following claims are intended to cover all of the generic and specific features of the invention herein described and all statements of the scope of the invention which, is a matter of language, might be said to fall there between.

What is claimed is:

1. A method for dynamically creating content in a three-dimensional virtual environment comprises:
creating at least one blank placeholder within a three-dimensional virtual environment; the at least one blank placeholder having a blank placeholder graphic information, the blank placeholder graphic information including the virtual shape and dimensions of the blank placeholder;
storing the blank placeholder graphic information
creating a virtual content asset having a virtual content asset shape information, and at least one business logic rule associated there with for displaying the virtual content asset;
pairing the virtual content asset with the blank placeholder graphic information by matching the blank placeholder graphic information and virtual content asset graphic information; and
determining whether a business logic rule of the one or more business logic rules is satisfied, and when the business logic rule is satisfied, inserting the virtual content asset as the blank placeholder.
